(19) United States
(12) Patent Application Publication
(10) Pub. No.: US 2007/0150713 A1
(43) Pub. Date: Jun. 28, 2007

(54) Methods and arrangements to dynamically modify the number of active processors in a multi-node system

(75) Inventors: Jason R. Almeida, Garner, NC (US); Scott N. Dunham, Raleigh, NC (US); Eric R. Kern, Chapel Hill, NC (US); William B. Schwartz, Apex, NC (US); Adam L. Soderlund, Bahama, NC (US)

Correspondence Address: IBM COPORATION (RTP);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 11/316,180

(22) Filed: Dec. 22, 2005

(51) Int. Cl. G06F 9/00

(52) U.S. Cl. 713/1

(57) ABSTRACT

Methods and arrangements to dynamically modify the number of processors active in a multi-node data processing system. are contemplated. Embodiments include transformations, code, state machines or other logic to change the portion of BIOS that a processor loads on power-on. In some embodiments, a signal sent over a GPIO pin may flip an address line to the portion of the BIO that a processor loads on power-on. In some embodiments, a service processor may set a GPIO or non-volatile RAM value. The portion of BIOS controlling the powering-up of the processor may read the value and branch depending upon the value. Embodiments also include transformations, code, state machines or other logic to determine the state of a dynamically activated processor. In some embodiments, a processor may read from a local scratch register to determine if it has been dynamically activated. If so, embodiments may then clear the scratch register and put the processor to sleep. Embodiments may then update the tables which describe the resources available to the processor.

### FIELD

The present invention is in the field of data processing systems. More particularly, the present invention relates to methods and arrangements to dynamically modify the number of active processors in a multi-node data processing system.

### BACKGROUND

A multi-node data processing system is made up of a multiple nodes, each of which may have its own processor or set of processors. A multi-node system might comprise, for example, 4 interconnected nodes, where each node comprises 8 processors, such that the overall system effectively offers 32 processors. A node is typically contained in a chassis. Each node typically contributes memory resources that are shareable among the interconnected nodes. Typically, the multiple nodes work in a coordinated fashion. A single operating system may, for example, control running applications and assigning application threads to the individual processors for execution. A multi-node system may include multiple service processor components which monitor and control the system. Each node may contain a service processor component. A service processor component may detect the nodes of the multi-node computer system and maintain a table which describes how the nodes connect up and communicate with one another. The multi-node data processing system may also include a suite of system management software. Multi-node systems may provide massive redundancy and power. Work assigned to a failing node may be reassigned to another node. They may therefore provide high system availability and performance. An example multi-node system is the xSeries® eServer™ x460 from the International Business Machines Corporation (IBM). (“xSeries” is a registered trademark, and “eServer” is a trademark, of IBM.)

Typically, a multi-node data processing system permits the handling of interrupts without shutting down the operating system of the multi-node data processing system. For example, multi-node systems based on the Intel architecture (x86) commonly support the system management mode. The system management mode may allow a current processor state to be saved and may allow the processor to perform system management functions such as handling interrupts without shutting down the operating system. A system management interrupt (SMI) is an interrupt that is handled in system management mode.

Multi-node data processing systems are typically modular. The number of nodes in the system and the number of processors active in a node may be changed. It may be desirable to change the number of processors active in a multi-node data processing system. Increasing the active processors may help meet increased processing needs of the system or may provide for upgrading the system to more advanced technology. For example, a node may initially be configured with no processors active. The node provides only memory and IO, but not processing power. As the processing needs of the system increase, it may be desirable to activate or add processors to the node. In many systems, only certain configurations of processors within a node may be permissible. For example, a system may limit the number of processors in a node to 0 or a power of 2, such as 1, 2 or 4. Similarly, decreasing the active processors may conserve resources when processing needs are low or may eliminate obsolete or non-functioning processors.

The processors to be added may already be physically present as a spare or as part of a “capacity on demand” program. Such a program helps solve the problem of fluctuating computer resource requirements. Computer resource requirements for business and government applications often increase over a time period due to sales or employee growth. Over the same time period, the resource requirements may fluctuate dramatically due to inevitable peaks and valleys of day to day operations or from increased loads for seasonal, period-end, or special promotions. The peak resource requirements within a time period may be every different from the valley resource requirements. In order to be effective at all time, the computerized resources of a business must be sufficient to meet the current fluctuating needs of the business as well as projected needs due to growth.

To address such fluctuating and ever increasing resource demands, a customer conventionally purchases computing resources capable of accommodating at least its current peak requirement while planning for future requirements which are likely to be elevated. Customers therefore face the prospect of investing in more computerized resources than are immediately needed in order to accommodate growth and operational peaks and valleys. At any given time, therefore, the customer may have excess computing capacity—a very real cost. Such costs can represent a major expenditure for any computer customer.

Computing architectures which support “capacity on demand” applications help remedy the problem of dealing with fluctuating needs for computer resources. These applications enable customers to own more computer resources than they have paid for. When the need for resources increases, due to a temporary peak demand or to permanent growth, customers may purchase or rent additional computer resources already installed on their computers. Such customers may obtain authorization in the form of security codes to activate these additional resources (on-demand computer resources), temporarily or permanently.

It may be desirable to control the changing of the number of processors active in a multi-node data processing system from a remote location. A remote server may, for example, provide an enablement code for adding processors to the system on-demand. Similarly, a management decision to activate more advanced processors may be made at a remote computer location. In current multi-node data processing systems, the activation of additional processors which is controlled from a remote location may require the powering down and rebooting of the systems. The resulting down time can have serious consequences. Multi-node data processing systems may be executing critical processes that require continuous up-time.

### SUMMARY OF THE INVENTION

The problems identified above are in large part addressed by methods and arrangements to dynamically modify the number of processors active in a multi-node data processing system. One embodiment provides a method to dynamically activate a processor in a multi-node data processing system. The method may involve starting up the operating system of the multi-node data processing system with a processor in a node inactive. The method may also involve receiving a signal remote from the multi-node data processing system related to the activation of the processor. The method may also involve dynamically activating the processor in response to the signal.

Another embodiment provides a method to determine the state of a processor in a multi-node data processing system. The method may involve powering on the processor. The method may further involve reading a value to indicate whether the processor was dynamically activated. The method may allocate resources for the use of the processor in dependence upon the value.

Another embodiment provides a system to dynamically activate a processor. The system may comprise a multi-node data processing system. The multi-node data processing system may comprise a plurality of interconnected nodes. At least one of the nodes may comprise a processor and an interrupt handler capable of dynamically activating a processor. The system to dynamically activate a processor may further comprise a remote server connected to the multi-node data processing system. The remote server may be configured to send the multi-node data processing system a signal related to the activation of the processor. The multi-node data processing system may be configured to receive the signal from the remote server and to dynamically activate the processor.

Another embodiment provides a multi-node data processing system to determine the state of a processor. The multi-node data processing system may comprise a plurality of interconnected nodes. The multi-node data processing system may also comprise a processor contained in one of the plurality of interconnected nodes. The multi-node data processing system may also comprise means for dynamically activating the processor. The multi-node data processing system may also comprise a register. The multi-node data processing system may also comprise means to write a value to the register to indicate whether the processor has been dynamically activated. The processor may be configured to read a value from the register during a power on self test to determine whether the processor has been dynamically activated.

Another embodiment provides machine-accessible medium containing instructions to dynamically activate a processor in a multi-node data processing system, which when the instructions are executed by a machine, cause said machine to perform operations. The operations may involve starting up the operating system of the multi-node data processing system with a processor in a node inactive. The operations may further involve receiving a signal remote from the multi-node data processing system related to the activation of the processor. The operations may further involve dynamically activating the processor in response to the signal.

### BRIEF DESCRIPTION OF THE DRAWINGS

Advantages of the invention will become apparent upon reading the following detailed description and upon reference to the accompanying drawings in which, like references may indicate similar elements:

FIG. 1 depicts an embodiment of a system for dynamically changing the number of active processors in a multi-node data processing system;

FIG. 2 depicts an example of a node in a multi-node data processing system capable of dynamically changing the number of active processors;

FIG. 3 depicts a flowchart of an embodiment to dynamically change the number of active processors in a multi-node data processing system; and

FIG. 4 depicts a flowchart of an embodiment to determine the state of a processor in a multi-node data processing system in which a processor can be dynamically activated.

### DETAILED DESCRIPTION OF EMBODIMENTS

The following is a detailed description of embodiments of the invention depicted in the accompanying drawings. The embodiments are in such detail as to clearly communicate the invention. However, the amount of detail offered is not intended to limit the anticipated variations of embodiments, but on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, methods and arrangements to dynamically modify the number of processors active in a multi-node data processing system are contemplated. Embodiments include transformations, code, state machines or other logic to change the portion of the basic input-output system (BIOS) that a processor loads on power-on. In some embodiments, a signal sent over a general purpose input-output (GPIO) pin may flip an address line to the portion of the BIOS that a processor loads on power-on. In some embodiments, a service processor may set a GPIO or non-volatile RAM value. The portion of BIOS controlling the powering-up of the processor may read the value and branch depending upon the value. Embodiments also include transformations, code, state machines or other logic to determine the state of a dynamically activated processor. In some embodiments, a processor may read from a local scratch register to determine if it has been dynamically activated. If so, embodiments may then clear the scratch register and put the processor to sleep. Embodiments may then update the tables which describe the resources available to the processor.

While specific embodiments will be described below with reference to particular circuit or logic configurations, those of skill in the art will realize that embodiments of the present invention may advantageously be implemented with other substantially equivalent configurations.

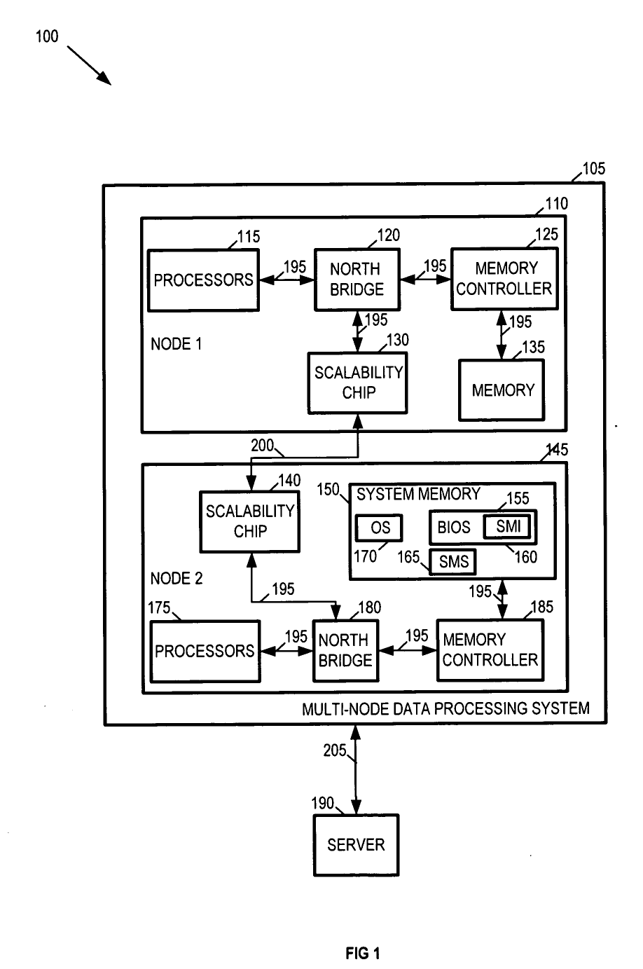

Turning now to the drawings, FIG. 1 depicts an embodiment of a system 100 for dynamically changing the number of active processors in a multi-node data processing system. System 100 includes a multi-node data processing system 105 which includes nodes 110 and 145 connected by a scalability cable 200. Multi-node data processing system 105 is connected to remote server 190 by connection 205. Connection 205 may, for example, consist of a network connection such as the Internet or a local-area or wide-area network. Each of nodes 110, 145 may comprise one or more processors 115, 175 that perform various computing functions. In other embodiments, some of the nodes may be processorless. The processors 115, 175 may be connected to each other via processor interconnect. Each of the processors 115, 175 may comprise service processor logic. The service processor logics may communicate with other each as well as with the north bridge 120, 180 to enable the processors 115, 175 to operate together in a coherent manner. In other embodiments, the service processor logic may be contained in a special-purpose processor or processors which are limited strictly to performing service processor functions. A memory controller 125, 185 in each of the nodes 110, 145 provides an interface between memory 135, 150 and other components of the node 110, 145.

A north bridge component 120, 180 may be present in each node. A north bridge component is present in a chipset architecture commonly known as north bridge, south bridge. In this architecture, the north bridge component communicates with one or more processors 115, 175 over a bus 195. The north bridge 120, 180 typically controls interactions with memory 135, 150; advanced graphics, a cache, and a peripheral component interconnect (PCI) bus. Bus 195 is commonly referred to as the front-side bus. The south bridge, not shown in FIG. 1, is generally responsible for input/output (IO) functions, such as serial port 10, audio, universal serial bus and so forth. Embodiments of the present invention are not limited to this north bridge, south bridge chipset, however, and thus the depiction in FIG. 1 should be construed as illustrative but not limiting.

The scalability chips 130, 140 comprise one or more control fields, and are leveraged by preferred embodiments to enable information to be communicated among the nodes 110, 145 of the multi-node system 105. Connecting the separate nodes 110, 145 with a scalability cable 200 at the scalability chips 100, 140 may enable the multiple nodes 110, 145 to function as a single computer. One of the nodes, node 145, in the multi-node system 105 may contain a system memory 150 coupled to the memory controller 185 for the node 145. The system memory 150 may store software for controlling the multi-node system 105 and executing application processes. The software may include the operating system (OS) 170, BIOS 160 which includes the system management interrupt (SMI) 155, and system management software (SMS) 165. The OS 170 may assign threads generated by applications programs to the various processors 115, 175 of the multiple nodes 110, 145 of the multi-node system 105 for execution. BIOS is programming that controls the basic hardware operations of a computer, including interaction with disk drives and IO devices. It is generally stored in non-volatile memory and loaded upon system start-up. SMI 155 is an interrupt that is handled in system management mode. Typically, a multi-node data processing system permits the handling of interrupts without shutting down the operating system of the multi-node data processing system. For example, multi-node systems based on the Intel architecture (x86) commonly support the system management mode. The system management mode may allow a current processor state to be saved and may allow the processor to perform system management functions such as handling interrupts without shutting down the operating system. In other embodiments, the multi-node data processing system 105 may be based upon a non-Intel architecture or an Intel architecture with a different interrupt architecture. SMS 165 may monitor information provided by the service processor logics and provide a graphical interface to a system administrator located at a separate computer. The system administrator may be able to change the configuration of the multi-node data processing system 105 through use of the SMS 165. In other embodiments, SMS 165 may reside on a separate data processing system. Other embodiments may not include an SMS separate from service processor logics.

The server 190 is remote from the multi-node data processing system 105 since it is connected over a network connection and not directly connected. The remote server 190 may send the multi-node data processing system 105 a signal related to changing the number of active processors in the multi-node data processing system 105. The remote serve 190 may, for example, provide the multi-node data processing system 105 with enablement codes for the enablement of on-demand computing resources such as processors. Upon receipt of the enablement codes, the multi-node data processing system 105 may dynamically enable one or more of processors 115, 175 which are a component of the multi-node data processing system 105 but have not been activated. As another example, a system administrator may control the multi-node data processing system 105 from remote server 190. The system administrator may send a command from the remote server 190 to the multi-node data processing system 105 to activate an additional processor. In addition, the multi-node data processing system 105 may determine the state of processors 115, 175 after activation. The multi-node data processing system 105 may determine whether one of the processors 115, 175 has been dynamically added after the rest of the system went into operation, or was brought up with the rest of the system. A processor is dynamically added (added “on the fly”) when it is added to the multi-node system without shutting down and restarting the operating system of the multi-node system.

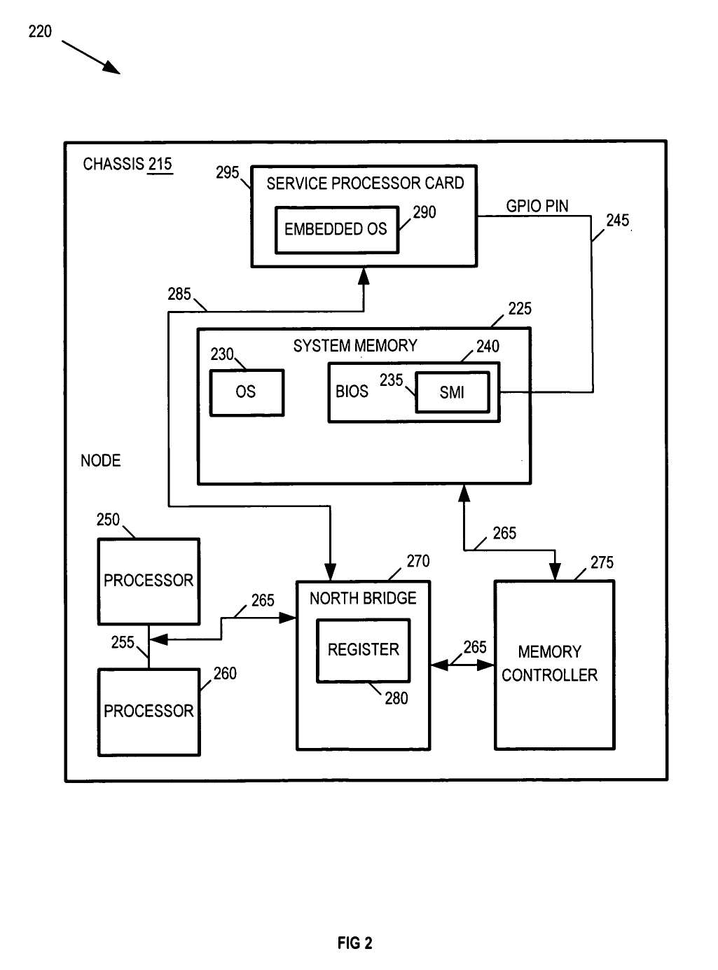

FIG. 2 depicts an example of a node 220 in a multi-node data processing system capable of dynamically changing the number of active processors which includes a chassis 215, processors 250, 260, a north bridge 270, a memory controller 275, system memory 225, and a service processor card 295. The processors 250, 260 are connected by processor interconnect 255. The processor interconnect 255 in turn is connected to the north bridge 270 by the system bus 265. The north bridge 270 contains a scratch register 280 which may be used to store parameters describing the functioning of the multi-node data processing system. The north bridge is connected to the memory controller 275 by system bus 265 and to the service processor card 295 by PCI bus 285. The memory controller 275 is connected to system memory 225 by system bus 265. System memory 225 may contain software controlling the operation of a multi-node data processing system. The software includes the operating system OS 230 and BIOS 240 which includes SMI 235. The service processor card 295 may constitute the primary mechanism for coordinating the various components of a multi-node data processing system. The service processor card 295 may contain an embedded operating system 290. A general purpose input output pin (GPIO pin) 245 provides a direct connection between the service processor card 295 and BIOS 240. In other embodiments, service processor logic may be carried out by the processors 250, 260. In other embodiments, the memory of a node may not include the system OS. In other embodiments, a node may have a different number of processors than two. In other embodiments, an interrupt architecture may be other than SMI. In other embodiments, the architecture of a node may be other than a north bridge, south bridge architecture.

The BIOS 240 may control the activation of processors 250, 260. Node 220 may have a primary processor 250. When the chassis 215 is powered on, the primary processor 250 may perform a power-on self test (POST). During POST, an electrical signal may clear left-over data from registers such as register 280. It may also set the program instruction counter to a specific address, the address of the next instruction for the primary processor 250 to begin executing. The address may refer to the beginning of a boot program for the primary processor 250 stored in the BIOS 240. The instructions may perform a series of system checks. In FIG. 2, the primary processor 250 may bring up processor 260 after performing the system checks. Primary processor 250 may then examine system data to determine if processor 260 is to be activated as part of the node. As a final step in bringing up the system, when all of the processors 250, 260 of node 220 are brought up, the primary processor 250 may look at scalability and the connections of the nodes. The nodes may not be connected until the very end of the process of bringing up the system.

When system data indicates that processor 260 is not to be connected up to the system, the primary processor 250 may place disable processor 260. In one embodiment, during boot, BIOS utilizes advanced configuration and power interface (ACPI) specification and/or the S3 state to put processor 260 in a low-power, standby, or off state. ACPI is a power management specification that makes hardware status information available to the operating system 230. ACPI system firmware describes a data processing system's characteristics by placing data organized into tables in main system memory. The initial removal of the processor 260 from the group of executing processors may occur before the BIOS 240 hands over control to the OS 230. In another embodiment, the primary processor 250 may disable processor 260 by placing processor 260 in a tight loop or spin cycle. Processor 260 may continuously execute a small set of instructions without performing any system work. The BIOS 240 may contain two or more sets of code for activating processors 250, 260. One set of code may bring up processor 260 normally connected to the system and the other set of code may disable the processor 260.

In the embodiment of FIG. 2, the service processor card 295 may receive a signal from a remote computer to change the number of active processors 250, 260. The service processor card 295 may, for example, receive an enablement code which enables the activation of a processor 260. Service processor card 295 may then send a signal over GPIO pin 245 to BIOS 235 which results in flipping the address line which refers to the code which brings up processors 250, 260. An address line may constitute an electrical circuit etched onto a RAM chip and associated with a specific location in RAM. To read or write from the address, a signal is sent along the address line to access data lines connected to the address line. The data lines may transmit the bit values of a word of data stored at the address associated with the address line. Flipping an address line is changing the address line referred to by a memory address. Before the enablement code is received, the address line may refer to start-up code which renders the processor 260 inactive. After the enablement code is received from a remote computer and the address line is flipped, the code loaded at power-on may constitute the code that brings up the processor 260 as an active part of the multi-node data processing system. The service processor card 295 may generate an SMI which powers down processor 260. The service processor may also allocate system resources such as memory and 10 for use by processor 260. The service processor card 295 may then power up processor 260. On start-up, processor 260 may load code from BIOS 240 which activates processor 260.

In other embodiments, other methods may be used to dynamically activate a processor. For example, BIOS 240 may branch depending upon a register value. For example, the service processor card 295 may set a GPIO or non-volatile RAM value which BIOS 240 reads to start-up node 220 with processor 260 active or disabled, depending upon the value. In other embodiments, node 220 may contain a different number of processors, a different number of active processors, and a different number of processors which are dynamically activated. For example, a processorless node with 8 processors may be brought up with all 8 processors disabled. All 8 processors may be dynamically activated. As another example, a node may be brought up with two of its 4 processors active. The other two may be dynamically activated.

In the embodiment of FIG. 2, when a multi-node data processing system is activated, the service processor card 295 may assign system resources to the various component nodes such as node 220. For example, a node with inactive processors may be merged into the multi-node data processing system as a node with memory and IO. The memory may be assigned to other processors in the system. If, later, the processors of the node are dynamically activated, it is important not to allocate to them node memory which has been allocated to other processors. Removing the memory from the processors using it may result in system failure. Thus, it is important to be able to determine the state of a processor such as processors 250, 260 when they are activated.

In the embodiment of FIG. 2, an activated processor may determine whether it has been dynamically activated by reading a value from the register 280 contained in the north bridge 270. When a processor 260 is dynamically activated, primary processor 250 or service processor card 295 may write a value to the register 280 to indicate the dynamic activation. On performing a POST, the dynamically activated processor 260 may read the value in the register 280. If the value indicates that the processor 260 was dynamically activated, the processor 260 may then rewrite the value in the register 280 to the default value indicating normal processor activation. The processor 260 may then sleep. When the dynamic activation was performed as a result of an SMI interrupt, the SMI interrupt handler 235 may poll the register 280 until the SMI interrupt handler 235 determines that the default value has been written to the register 280. The SMI interrupt handler may then update ACPI tables to indicate the new configuration. If, on the other hand, one of processors 250, 260 is activated normally, the value of register 280 may be the normal value. The processor 250, 260 will proceed with the normal power-on routine. In other embodiments, different methods of determining the state of a processor may be utilized. For example, a processor 250, 260 may read system tables to determine the available resources on power-up. If a processor 250, 260 is dynamically activated, the system tables may be updated and the processor 250, 260 powered down. Then, the processor 250, 260 may be powered up and may read the revised system tables. In other embodiments, the resources allocated to a processor 250, 260 may be modified without powering down the processor 250, 260.

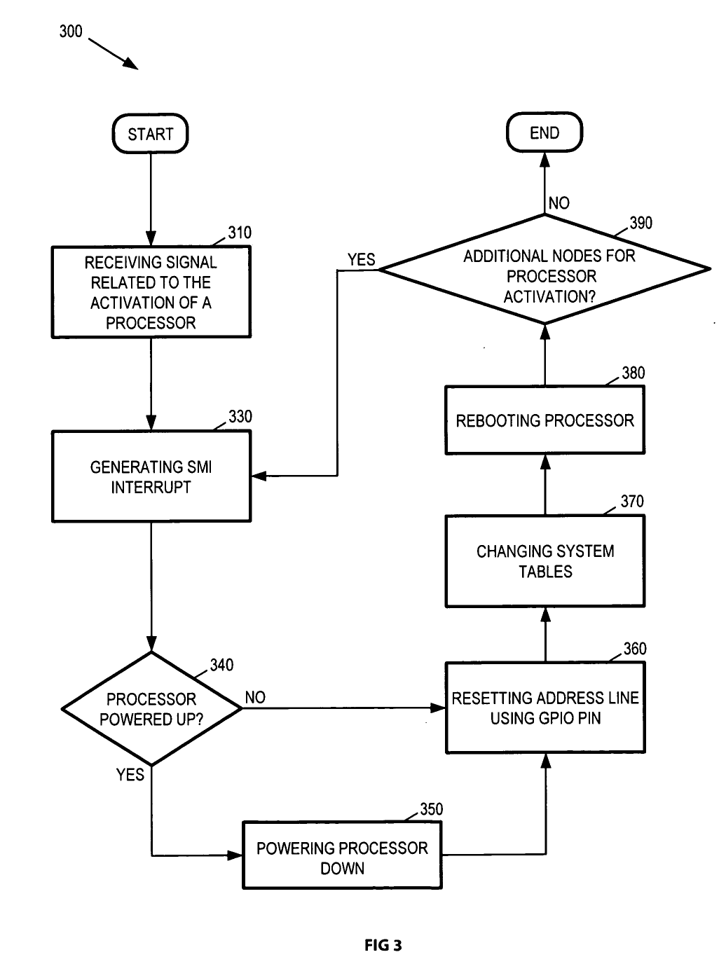

Referring now to FIG. 3, there is shown a flowchart of an embodiment to dynamically change the number of active processors in a multi-node data processing system. The multi-node data processing system may contain processors physically present in one of the nodes, but disabled. For example, the system may comprise an on-demand system. The system may have been shipped with some of the processors disabled. As another example, the system may contain disabled processors which are available as backup. Flow chart 300 begins with receiving a signal remote from the multi-node data processing system related to the activation of a processor (element 310) for the multi-node data processing system. For example, in the case of an on-demand system, a system administrator may determine that the system requires additional processing capacity and a financial agent may purchase additional capacity. The supplier of the system may then send an enablement code for the activation of the disabled processors. The sending of the enablement code may constitute a signal related to the activation of a processor. As another example, a system administrator operating at a computer connected to the multi-node data processing system over a network may decide to active backup processors to replace processors which are obsolete or in danger of failing. The system administrator may send a message to the multi-node data processing system over the network to activate some of the spare processors. In either example, the multi-node data processing system may receive the signal.

The system may then generate an SMI interrupt (element 330). The SMI interrupt handler may determine whether the processor to be activated is powered up (element 340). The processor may, for example, be executing a spin cycle. If so, the SMI interrupt handler may power the processor down (element 350). Once the processor is powered down, the SMI interrupt handler may reset an address line for the processor by sending a signal over a GPIO (general purpose input/output pin) (element 360). The address line may be associated with the location in BIOS that the processor loads upon start-up. By resetting the address line, the SMI interrupt handler can change the code that controls starting up the processor.

The SMI interrupt handler can modify system tables which describe how the nodes of the multi-node data processing system connect up and how they communicate (element 370). The modified tables may indicate that the processor to be activated is to be connected to the system. The SMI interrupt handler may then reboot the processor to be activated (element 380). During the boot process, the processor may go through the POST procedure and load code from system BIOS. As a result of the reset address line (element 360), the processor may load code that activates the processor. The system may check if it has received signals for the activation of other nodes (element 390). If so, each element from 310 to 380 may be repeated. If not, dynamic activation of the processor may end.

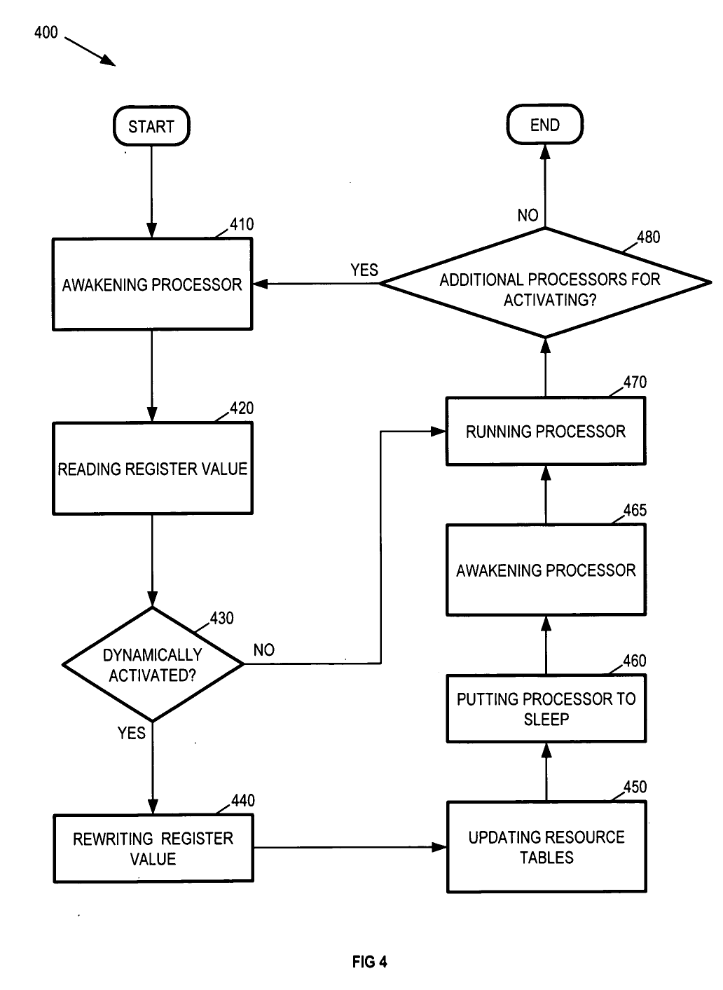

Referring now to FIG. 4, there is shown a flowchart of an embodiment to determine the state of a processor in a multi-node data processing system which provides for the dynamic activation of a processor. Flow chart 400 begins with the awakening of a processor (element 410). For example, a processor may be powered-up with the other processors in the system during an ordinary system boot. As another example, a backup processor may be activated dynamically. As another example, a processor may be dynamically activated on-demand. The awakened processor may read a register value which indicates the state of the processor (element 420). The register may be part of the chipset register of the node containing the processor. The value of the register may indicate the state of the processor (element 430). The default value of the register, the value to which it is set on normal start-up, may indicate that the processor was not dynamically. A different value of the register may indicate that the processor was dynamically activated. For example, when a processor is to be dynamically activated, another processor or an SMI handler may write a value to the register to indicate to the processor that it has been dynamically activated.

If the register value indicates that the processor was dynamically activated, the processor may rewrite the register value to the default value (element 440). The system may then update resource tables (element 450) to reconfigure memory and IO for use by the processor. Resources that may ordinarily be available to the processor may have been reassigned because the system was powered up with the processor disabled. For example, the processor may reside on a blade that was powered up with no active processors. The memory on the blade may have been reassigned to other processors and may not be available to the dynamically activated processor. The system may awaken the processor (element 465) and run the processor (element 470). If there are other processors for activating (element 480), each element from 410 to 470 may be repeated. If not, determining the state of a processor in a multi-node data processing system which provides for the dynamic activation of a processor may end.

Another embodiment of the invention is implemented as a program product for implementing the dynamic activation of a processor in a multi-node data processing system such as multi-node data processing system 105 illustrated in FIG. 1. The program(s) of the program product defines functions of the embodiments (including the methods described herein) and can be. contained on a variety of data and/or signal-bearing media. Illustrative data and/or signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such data and/or signal-bearing media, when carrying computer-readable instructions that direct the functions of the present invention, represent embodiments of the present invention.

In general, the routines executed to implement the embodiments of the invention may be part of an operating system or a specific application, component, program, module, object, or sequence of instructions. The computer program of the present invention typically is comprised of a multitude of instructions that will be translated by a computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates methods and arrangements to dynamically activate a processor in a multi-node data processing system. It is understood that the form of the invention shown and described in the detailed description and the drawings are to be taken merely as examples. It is intended that the following claims be interpreted broadly to embrace all the variations of the example embodiments disclosed.

Although the present invention and some of its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method to dynamically activate a processor in a multi-node data processing system, the method comprising:
starting up the operating system of the multi-node data processing system with a processor in a node inactive;
receiving a signal remote from the multi-node data processing system related to the activation of the processor; and
dynamically activating the processor in response to the signal.

2. The method of claim 1, wherein starting up the operating system of the multi-node data processing system with a processor in a node inactive comprises:
removing the processor from the system; and
locking down and disabling the processor.

3. The method of claim 2, wherein locking down and disabling the processor comprises placing the processor in a sleep state.

4. The method of claim 2, wherein locking down and disabling the processor comprises placing the processor in a spin lock.

5. The method of claim 1, wherein receiving a signal remote from the multi-node data processing system related to the activation of the processor further comprises receiving an enablement code for the on-demand activation of the processor.

6. The method of claim 1, wherein dynamically activating the processor comprises:
generating a service management interrupt of the node; and
rebooting the node.

7. The method of claim 6, wherein dynamically activating the processor comprises:
receiving a signal in a general purpose input-output pin (GPIO pin);
flipping an address line; and
booting up basic input-output system (BIOS) from the address specified by the flipped address line.

8. A method to determine the state of a processor in a multi-node data processing system, the method comprising:
powering on the processor;
reading a value to indicate whether the processor was dynamically activated; and
allocating resources for the use of the processor in dependence upon the value.

9. The method of claim 8, wherein reading a value further comprises reading a value indicating that the processor was dynamically activated; and further comprising:
changing the value;
putting the processor to sleep;
updating system tables of resource allocation to the processor; and
awakening the processor.

10. The method of claim 8, wherein reading the value comprises reading the value of a chipset scratch register; and
further comprising writing a non-flush value to the chipset scratch register

11. A system to dynamically activate a processor, the system comprising:
a multi-node data processing system comprising:
a plurality of interconnected nodes, wherein:
at least one of the nodes comprises:
a processor; and
an interrupt handler capable of dynamically activating a processor; and
a remote server connected to the multi-node data processing system, the remote server configured to send the multi-node data processing system a signal related to the activation of the processor; wherein the multi-node data processing system is configured to receive the signal from the remote server and to dynamically activate the processor.

12. The system of claim 11, wherein the multi-node data processing system is configured according to the x86 architecture.

13. The system of claim 11, wherein the at least one of the nodes comprises a basic input output system (BIOS) that supports system management interrupt (SMI).

14. The system of claim 12, wherein the at least one of the nodes comprises:
a service processor card; and
a general purpose input-output pin connecting the service processor card to the BIOS of the node, wherein the service processor card is configured to modify the reset vector of the processor of the at least one of the nodes.

15. The system of claim 11, wherein the remote server is configured to send the multi-node data processing system an enablement code to enable the on-demand activation of the processor of the at least one of the nodes.

16. A multi-node data processing system to determine the state of a processor, the multi-node data processing system comprising:
a plurality of interconnected nodes;
a processor contained in one of the plurality of interconnected nodes;
means for dynamically activating the processor;
a register; and
means to write a value to the register to indicate whether the processor has been dynamically activated; wherein
the processor is configured to read a value from the register during a power on self test to determine whether the processor has been dynamically activated.

17. The system of claim 16, wherein the means for dynamically activating the processor comprises a basic operating system that supports system management interrupt.

18. The system of claim 16, wherein the register comprises a chipset register local to the one of the plurality of interconnected nodes containing the processor.

19. A machine-accessible medium containing instructions to dynamically activate a processor in a multi-node data processing system which when the instructions are executed by a machine, cause said machine to perform operations, comprising:
starting up the operating system of the multi-node data processing system with a processor in a node inactive;
receiving a signal remote from the multi-node data processing system related to the activation of the processor; and
dynamically activating the processor in response to the signal.

20. The machine-accessible medium of claim 19, wherein the operations further comprise:
receiving a signal in a general purpose input-output pin (GPIO pin);
flipping an address line; and
booting up basic input-output system (BIOS) from the address specified by the flipped address line.

21. The machine-accessible medium of claim 19, wherein the operations further comprise:
powering on the processor;
reading a value to indicate whether the processor was dynamically activated; and
allocating resources for the use of the processor in dependence upon the value.
